(19) United States
(12) Patent Application Publication
(10) Pub. No.: US 2016/0297725 A1
(43) Pub. Date: Oct. 13, 2016

(54) FERTILIZER GRANULES HAVING POLYMERIC COATING FORMED WITH A DIOL

(71) Applicant: AGRIUM ADVANCED TECHNOLOGIES (U.S.) INC., Loveland, CO (US)

(72) Inventors: Young G No, Birmingham, AL (US); Kai Chen, Birmingham, AL (US); Sriramakrishna Maruvada, Birmingham, AL (US)

(73) Assignee: Agrium U.S. Inc., Denver, CO (US)

(21) Appl. No.: 15/029,918

(22) PCT Filed: May 16, 2014
(86) PCT No.: PCT/US2014/038395

§ 371 Date: Apr. 15, 2016

Related U.S. Application Data
(60) Provisional application No. 61/892,165, filed on Oct. 17, 2013.

(51) Int. Cl. C05G 3/00; C05B 17/00; C05C 11/00; C05D 9/02; C05D 5/00; C05C 9/00; C05D 1/00

(52) U.S. Cl. CPC C05G 3/0029; C05C 9/005; C05B 17/00; C05D 1/005; C05D 9/02; C05D 5/00; C05C 11/00

(57) ABSTRACT

A controlled release fertilizer composition and methods to produce the controlled release fertilizer composition. The controlled release fertilizer composition includes a fertilizer core that is coated with a polymeric layer, such as polyurethane, that includes a small molecule diol.

### CROSS REFERENCE TO RELATED APPLICATIONS

This application claims the benefit of U.S. Provisional application No. 61/892,165 filed Oct. 17, 2013 entitled “FERTILIZER GRANULES HAVING POLYMERIC COATING FORMED WITH A DIOL”, the entire disclosure of which is incorporated herein.

### FIELD OF THE DISCLOSURE

This invention relates to controlled release fertilizer compositions. Particularly, the invention relates to controlled release fertilizers having a core coated with a polymeric layer.

### BACKGROUND

Fertilizers have been used for many years to supplement plant nutrients in soil or other growing media. In recent years the art has focused on techniques to deliver controlled amounts of plant nutrients to the soil or other growing media. It is recognized, for example, that controlling the release of plant nutrients such as nitrogen from highly soluble fertilizer granules is desirable because releasing the nutrients over an extended period of time achieves advantages which include increased efficiency of fertilizer use by plants, reduced application costs since fewer applications of fertilizer are required and reduced nutrient loss caused by leaching and denitrification. Applying a coating on the surface of the fertilizer granules may reduce the dissolution rate of the granules and impart controlled-release characteristics. In essence, the water in the soil and rainwater are kept away from the very soluble fertilizer until a granule develops a flaw such as a crack or fissure in the coating or the coating develops porosity upon exposure to water.

Polymer coated fertilizers have received substantial attention, particularly in view of the improved controlled release properties obtained with certain polymer coatings at lower coat weights. The polymer-coated fertilizers may have multiple coating layers. Examples of polymeric fertilizer coatings include: an inner coating of a urethane reaction product derived from reacting isocyanate and polyol, with an outer coating of an organic wax; an oleo polyol(s) coating; or a polyurea coating formed by applying an isocyanate-reactive component containing at least two amine groups and subsequently applying a polyisocyanate.

### SUMMARY

Polymer coated fertilizers as described above have received substantial attention, but they are expensive to manufacture. There is a need to provide lower-cost controlled release fertilizer formulations that are abrasion resistant.

The present disclosure provides abrasion resistant, controlled release fertilizer particles, the particles having a polyurethane coating formed from an isocyanate, a polyol, and a small molecule diol. The coating is particularly suited for increasing the abrasion resistance on fertilizer core particles.

In one particular embodiment, this disclosure provides a controlled release fertilizer composition comprising a plant nutrient core having an outer surface, and a polymeric coating on the outer surface, the polymeric coating comprising an isocyanate, a polyol, and a small molecule diol, the diol at a level of no more than 4 wt-% of the polymeric coating.

In another particular embodiment, this disclosure provides a controlled release fertilizer composition comprising a plant nutrient core having an outer surface, and a polymeric coating on the outer surface, the polymeric coating comprising an isocyanate, a polyol, and a small molecule diol, the diol at a level of no more than 0.5 wt-% of the fertilizer composition, in some embodiments no more than 0.3 wt-%.

In yet another particular embodiment, this disclosure provides a process of using a controlled release fertilizer composition. The process includes providing a controlled release fertilizer having a plant nutrient core coated with a polymeric coating comprising a small molecule diol, either applying the controlled release fertilizer to a surface or incorporating the controlled release fertilizer into a growing medium, exposing the applied or incorporated fertilizer to moisture.

Non-limiting examples of small molecule diols suitable for the control release fertilizer composition include ethylene glycol, 1,3-propanediol, 1,4-butanediol, 2-methyl-1,3-propanediol, 1,6-hexanediol, triethylene glycol, tetraethylene glycol, 2-butyl-2-ethyl-1,3-propanediol, 3-methyl-1,5-pentanediol, 2-ethyl-1,3-hexanediol, or combinations thereof.

These and various other features and advantages will be apparent from a reading of the following detailed description.

### DISCUSSION OF THE INVENTION

The present invention relates to a controlled release fertilizer composition comprising a particulate fertilizer or plant nutrient surrounded by a polymeric coating that was formed with a small molecule diol in addition to an isocyanate and a polyol.

The choice of particulate plant nutrient material useful for the present controlled release fertilizer material is not to be restricted. The present fertilizer material is described herein primarily with reference to urea as the plant nutrient. As will be apparent to one skilled in the art, however, other nutrients, including primary nutrients, secondary nutrients and micronutrients, can be used to prepare the controlled release fertilizer compositions in accordance with the present invention. Typically, the plant nutrient material is provided in the form of a water soluble particulate material. The plant nutrient present within the controlled release fertilizer according to the various embodiments of the present invention, as described herein, can include primary nutrients such as urea, ammonium nitrate, potassium nitrate, ammonium phosphates and other suitable nitrogen derivatives; potassium phosphates and other suitable phosphorus derivatives; and potassium nitrate, potassium sulfate, potassium chloride and other suitable potassium derivatives as well as mixtures of these primary nutrients. Additionally, the plant nutrient can include a suitable secondary nutrients and micronutrients. Suitable micronutrients include, but are not limited to iron sulfates, copper sulfate, manganese sulfate, zinc sulfate, boric acid, sodium molybdate and its derivatives, magnesium sulfate, potassium/magnesium sulfate, and derivatives and mixtures thereof.

Urea is characterized as having functional reactive groups at the surface of the urea which may be used to react with a diisocyanate when forming the polymer layer. This reaction causes the polymer layer to be chemically bonded to the urea. However, according to the present invention, it is not required that the polymer layer be bonded to the urea material.

The amount of nutrients present within the controlled release fertilizer composition as describe herein may vary as follows, where the listed amounts are weight percentages (wt. %) based on the weight of the fertilizer composition:
Nitrogen derivatives (as nitrogen): 0 wt. %-45.54 wt. %
Phosphorus derivatives (as P₂O₅): 0 wt. %-51.48 wt-%
Potassium derivatives (as K₂O): 0 wt. %-61.38 wt. %
Iron Sulfate: 0 wt. %-99 wt. %
Iron EDTA chelate: 0 wt. %-99 wt. %
Copper Sulfate: 0 wt. %-99 wt. %
Manganese Sulfate: 0 wt. %-99 wt. %
Zinc Sulfate: 0 wt. %-99 wt-%
Sodium Molybdate: 0 wt. %-99 wt. %
Sodium Borate: 0 wt. %-99 wt. %, and/or
Magnesium Sulfate: 0 wt. %-99 wt. %.

The particulate plant nutrient material, or fertilizer core, of the controlled release fertilizer composition of the present invention is coated with a polymeric coating. Examples of suitable polymeric coatings include polyurethane or coatings comprising polyesters such as alkyd or a modified alkyd resin, epoxy resins, aminoplastic resins, ureaformaldehyde thermosets, melamine-formaldehyde thermosets, phenolic thermosets, polyimide thermosets, unsaturated polyester thermosets, and mixtures thereof. The polymeric coating can be a thermosetting polymeric coating. The polymeric coating may be formed by multiple layers, and in some embodiments, the coating has at least three layers, in other embodiments at least four layers.

As indicated above, the polymeric coating on the controlled release fertilizer core may be a polyurethane; this coating may be produced using three or more than three precursor compounds. For example, one of the precursor compounds is an isocyanate, such as a diisocyanate or a polyisocyanate. A non-limiting example of a suitable diisocyanate is polymeric MDI (4,4 diphenylmethane diisocyanate). Other poly-functional isocyanates can be used, as described in U.S. Pat. No. 4,804,403, incorporated herein by reference (Moore; see for example Column 8, line 64 to Column 9, line 2 and Example 1), and include aliphatic, aromatic, and aliphatic aromatic polyisocyanates. Isocyanates contain two or more —NCO groups available for reaction and, as known to one skilled in the art, are widely used in the production of urethane polymers. Non-limiting examples of suitable isocyanates include: 1,6-hexamethylene diisocyanate, 1,4-butylene diisocyanate, furfurylidene diisocyanate, 2,4-toluene diisocyanate, 2,6-toluene diisocyanate, 2,4′-diphenylmethane diisocyanate, 4,4′-diphenylmethanie diisocyanate, 4,4′-diphenylpropane diisocyanate, 4,4′-diphenyl-3,3′-dimethyl methane diisocyanate, 1,5-naphthalene diisocyanate, 1-methyl-2,4-diisocyanate-5-chlorobenzene, 2,4-diisocyanato-s-triazine, 1-methyl-2,4-diisocyanato cyclohexane, p-phenylene diisocyanate, m-phenylene diisocyanate, 1,4-naphthalene diisocyanate, dianisidine diisocyanate, bitoluene diisocyanate, 1,4-xylylene diisocyanate, 1,3-xylylene diisocyanate, bis-(4-isocyanatophenemethane, bis-(3-methyl-4-isocyanatophenyl)methane, polymethylene polyphenyl polyisocyanates and mixtures thereof.

The second of the three or more than three precursor compounds used to form a polyurethane polymeric coating is a polyol, for example, as described in U.S. Pat. No. 4,804,403 (Moore; see for example, Column 9, lines 3-20, and Example 1). Non-limiting examples of polyols include diethylene glycol polyol, ethylene glycol, polypropylene glycol, organic polyols, orthophathalate diethylene glycol based polyester polyols, terephthalate-diethylene glycol based polyester polyols, castor oil and oils modified to contain amine or OH groups, for example modified tung oil, vegetable oils such as soybean oil, canola oil, sunflower oil, linseed oil. See, for example, U.S. Pat. No. 6,364,925 (Markusch et al., Column 8, line 39 to Column 9, line 27 and the examples); and U.S. Pat. No. 6,358,296, incorporated herein by reference (Markusch et al., see for example Column 9, lines 1 to 13, and the examples), oleo-polyols, for example epoxidized castor oil, epoxidized sunflower oil, epoxidized linseed oil as described in U.S. Pat. No. 6,358,296 (Markusch et al.), polyether polyols, castor oil derivatives for example partial hydrolysates of castor oil, formed by reacting castor oil with a polyol selected from diols (e.g. ethylene glycol, propylene glycol, 1,4-butanediol, neopentyl glycol, 1,6-hexanediol, diethylene glycol, dipropylene glycol, polyethylene glycol, and polypropylene glycol), glycerol, trimethylolpropane, and polyether polyol, or esters formed by reactions between ricinoleic acid and the polyol selected from the compounds as described in U.S. Pat. No. 6,176,891 (Komoriya et al.; see for example Column 7, lines 4 to 16, Column 8, lines 49 to 62; which is incorporated herein by reference), or any combinations thereof. Cross linked glyceride mixtures, mono- and di-glyceride mixtures that are not cross linked, and other cross linked polyols can also be used to form a polyurethane polymeric coating (see for example, U.S. application Ser. Nos. 13/291,681 and 13/291,698, both filed Nov. 8, 2011 and incorporated herein by reference).

A ratio of NCO groups from the isocyanate to the hydroxyl groups in the polyol is from about 0.8 to about 3.0, or about 0.8 to about 2.0, or even about 0.8 to about 1.5. In some embodiments, a ratio of NCO groups from the isocyanate to the hydroxyl groups in the mixture of a diol with polyol is in the range of about 0.8 to about 3.0, or about 0.8 to about 2.0, or even about 0.8 to about 1.5.

The third of the three or more than three precursor compounds used to form a polyurethane polymeric coating is a small molecule diol. The small molecule diol may be any diol whose equivalent weight is no greater than 25% of the polyol equivalent weight, or, that has an equivalent weight less than or equal to 25% of the polyol equivalent weight. Particular examples of small molecular diols suitable for the controlled release fertilizer composition include ethylene glycol, 1,3-propanediol, 1,4-butanediol, 2-methyl-1,3-propanediol, 1,6-hexanediol, triethylene glycol, tetraethylene glycol, 2-butyl-2-ethyl-1,3-propanediol, 3-methyl-1,5-pentanediol, and 2-ethyl-1,3-hexanediol.

The polymer coating that surrounds the plant nutrient core is present in an amount in the range of from about 0.5 to about 20 wt-%, or any amount therebetween, of the final fertilizer composition. For example, the polymeric coating may be from about 1 to about 10 wt-%, or from about 2 to about 4 wt-%, or any amount therebetween, of the final fertilizer composition. As another example, the polymeric coating may be from about 0.5 to about 4.5 wt-%, or any amount therebetween, of the final fertilizer composition. Particular, non-limiting examples of suitable polymeric coating weights include 0.5, 0.7, 1.0, 1.2, 1.4, 1.6, 1.8, 2.0, 2.2, 2.4, 2.6, 2.8, 3.0, 3.1, 4.2, 4.3, 4.5, 6.2, 6.3, 6.5 8.2, 8.3, 10, 15 and 20 wt-% based on the weight of the coated fertilizer composition.

A second or additional coating may be present either between the polymer coating and the fertilizer core as an intermediate layer or positioned outside of the polymer coating as an outer layer. In some embodiments, the second or additional coating layer is a distinct layer within the polymer coating. Preferred materials that may be used for the intermediate or outer layer include, but are not limited to, a petroleum product, a wax, a paraffin oil, a bitumen, an asphalt, a lubricant, a coal product, an oil, canola oil, soybean oil, coconut oil, linseed oil, tong oil, vegetable wax, animal fat, animal wax, a forest product, tall oil, modified tall oil, tall oil pitch, pine tar, a synthetic oil, a synthetic wax, a synthetic lubricant, an ethylene-vinyl acetate copolymer, an ethylene-acrylic acid copolymer; an ethylene-ethyl acrylate copolymer, an ethylene-vinyl alcohol copolymer, ethylene-vinyl alcohol-vinyl acetate terpolymers, a surfactant, a soap and a combination thereof. In some embodiments, if the additional layer is an outer layer, the layer is then a water-insoluble layer.

In accordance with this invention, the polymeric coating comprises at least one small molecule diol. Examples of small molecular diols include ethylene glycol, 1,3-propanediol, 1,4-butanediol, 2-methyl-1,3-propanediol, 1,6-hexanediol, triethylene glycol, tetraethylene glycol, 2-butyl-2-ethyl-1,3-propanediol, 3-methyl-1,5-pentanediol, and 2-ethyl-1,3-hexanediol. The presence of the diol, together with isocyanate and polyol in a polyurethane coating, has been surprisingly found to increase the longevity of the coated fertilizer composition when compared to a fertilizer composition having the same amount of polyurethane coating but formed without a diol.

The small molecule diol is present at a level of at least 0.05 wt-% of the abrasion-resistance controlled release fertilizer composition, in some embodiments at least 0.1 wt-%. Additionally, the diol is present at a level of no more than 0.5 wt-% of the abrasion-resistance controlled release fertilizer composition, in some embodiments no more than 0.3 wt-% or 0.25 wt-% or 0.2 wt-%, and in other embodiments no more than 0.15 wt-%. Particular, non-limiting examples of diol weights include 0.05, 0.06, 0.07, 0.08, 0.09, 0.1, 0.12, 0.15, 0.2, 0.25, 0.3, 0.4, 0.5% by weight based on the weight of the fertilizer composition.

The small molecule diol may be present homogeneously throughout the polymeric coating, or may be confined to one or more layers within the coating. The diol is present at a level of at least 0.5 wt-% of the polymeric coating, in some embodiments at least 1 wt-%. Additionally, the diol is present at a level of no more than 4 wt-% of the polymeric coating, in some embodiments no more than 3.5 wt-%. In some embodiments, the diol is present at a level of between 1 wt-% to 3 wt-%, in other embodiments at a level between 1.5 wt-% and 2.75 wt-%, based on the weight of the polymeric coating on the fertilizer core.

For embodiments where the polymeric coating is a polyurethane coating formed by reacting isocyanate and polyol(s), the small molecule diol may be present in or with the isocyanate, the polyol, or both. The diol is present at a level of at least 1 wt-% of the polyol, in some embodiments at least 2 wt-%. Additionally, the diol is present at a level of no more than 6% by weight of the polyol, in some embodiments no more than 5.5 wt-% of the polyol. In some embodiments, the diol is present at a level from 2 wt-% to 5.5 wt-%, or from 2.2 wt-% to 4.5 wt-%, or any amount therebetween. Particular, non-limiting examples of suitable diol weights include 1, 1.5, 2.1, 2.2, 2.5, 3, 3.3, 3.5, 4, 4.2, 4.4, 5, 5.3 and 5.5% by weight based on the weight of the polyol(s). Similarly, the diol is present at a level of at least 1 wt-% of the isocyanate (s), in some embodiments at least 2 wt-%. Additionally, the diol is present at a level of no more than 6 wt-% of the isocyanate, in some embodiments no more than 5.5 wt-% of the isocyanate. In some embodiments, the diol is present at a level from 2 wt-% to 5.5 wt-%, or from 2.2 wt-% to 4.5 wt-%, or any amount therebetween.

The present invention also provides a method of producing a controlled release fertilizer composition that comprises coating a plant nutrient compound with three or more than three precursor compounds that react to form a polymer, with one of the precursor compounds being a small molecule diol.

The controlled release fertilizer composition may be produced using a rotating drum to produce the polymer layer over and around fertilizer core granules. In this procedure, fertilizer granules, having a size range from about 1 mm to about 3 mm, or any size therebetween, for example about 1.5 mm to about 2 mm or any size therebetween, are fed from a storage area, onto a conveyor and fed into a rotating drum, or a pre-heater. If a drum is used, in a first section of the rotating drum, the fertilizer granules may be preheated to about a temperature between 120° F. and 250° F., or any temperature therebetween, for example from about 150° F. to about 200° F., or about 120, 125, 130, 135, 140, 145, 150, 155, 160, 165, 170, 175, 180, 185, 190, 195, 200, 205, 210, 220, 240, 230, 240, 250° F., or any amount therebetween, for example about 170° F. The heated granules are then coated with precursor compounds to produce the polymer coating. For example if the polymer coating comprises a polyurethane polymer, polymeric MDI (4,4 diphenylmethane diisocyanate), and DEG (diethylene glycol) polyols, optionally mixed with TEA (triethanolamine) as a catalyst and/or cross-linker, are simultaneously or sequentially applied to the fertilizer core granules, and the polymer components polymerize on the surface of the granules to form a polymer coating. The diol material can be present in either or both the MDI and polyols prior to addition to the rotating drum.

If desired, a water-insoluble coating may be applied onto the polymer-coated granule through nozzles within a second drum. The water-insoluble layer, for example a wax, may be applied at a temperature of about 120° F. to about 250° F., or any temperature therebetween, for example from about 150° F. to about 200° F., or any amount therebetween, for example about 160° F.

The release rate and durability of the controlled release fertilizer composition may be determined on either the unabraded or the abraded fertilizer composition or coated fertilizer product. For example, to determine the release rate and durability of an abraded fertilizer composition or product, an Impact Test or other test may be used to abrade the composition or product in order to determine the integrity of the abraded coated fertilizer composition or product. The Impact Test may involve dropping, for example, 30 grams of the coated product through a 20 foot long, 3-6 inch diameter tube onto a metal plate, followed by determining the release rate of the fertilizer component from the abraded fertilizer product.

To determine the release rate of either the unabraded or abraded fertilizer composition or product, about 10-20 grams of the composition to be tested (e.g., an unabraded or abraded (e.g., dropped) fertilizer composition or product) are placed in 150-200 ml of water at selected temperatures (e.g., 20° C. and 30° C.), and water samples are drawn at different time intervals (e.g., 1 day, 2 days, 4 days, 7 days, 9 days, 11 days, 14 days, etc.). The water samples are tested for fertilizer content using an appropriate test for the fertilizer material. For example, in the case of a urea-based fertilizer, urea and ammoniacal nitrogen of the sample may be determined using any suitable test, for example, the methods outlined by the Association of Official Analytical Chemists (AOAC). The AOAC also has methods outlined for the determination of potassium (expressed as weight % K₂O) for muriate of potash (MOP), the phosphate in phosphate sources, such as monoammonium phosphate (MAP), expressed as weight % P₂O₅, the ammonium and nitrogen in ammonium nitrate containing sources (expressed as weight % N). The AOAC also has analytical methods for the determination of micronutrients such as iron (Fe), copper (Cu), and zinc (Zn).

Results from such testing demonstrate that the controlled release fertilizer composition of the present invention, comprising a small molecule diol in a polymeric coating on the fertilizer core, provide improved abrasion properties, by increased time release of the fertilizer component, when compared to a similar fertilizer composition with no diol.

The controlled released fertilizer composition of the present invention will be illustrated with reference to the following examples.

The following materials were used for the following examples:

Polyol, Castor oil

Viscosity, cps @25° C. 600 min.-900 max.

Hydroxyl value, mg KOH/g 160 min.-170 max. (equiv. wt range 330-350)

% water 0.2 max.

functionality 2.7

Polymeric MDI, M 20 S (from BASF)

Viscosity, cps @25° C. 200

Acidity 0.05

NCO content, % 31.8

Equivalent weight, g/equiv. 132

Density, g/cm³ 1.23

Catalyst/cross-linker: Triethanol Amine (TEA)

Equivalent weight, g/equiv. 49.7

Catalyst/cross-linker: QUADROL (Q) (from BASF)

Equivalent weight, g/equiv. 70.0

PDO: 1,3-propanediol (from Sigma Aldrich)

EG: ethylene glycol (from Sigma Aldrich)

BDO: 1,4-butanediol (from Sigma Aldrich)

MPD: 2-methyl-1,3 propane diol (from Sigma Aldrich)

Wax; C30+ HA alpha-olefin wax (from CP Chemical)

Urea particulate (SGN 300)

U.S. standard series sieve range −5+10

Method for Coating Fertilizer Particles

For all samples coated below, 1 kg of urea was loaded into a 12 inch diameter drum and heated to 70° C. with an electric heat gun while the drum was rotating. A primer of 1 gram TEA and 1.5 grams MDI was applied first to the urea. The remainder of the coating was applied in multiple layers, each layer being a reaction product of a polyol mixture with MDI. The polyol mixture included wax, catalyst, small molecule diol and polyol. The percentages of each of these ingredients varied across the samples and are identified in the individual examples below. The polyol mixture was heated to 115° C. on an electric hotplate. The desired amounts of the polyol mixture and the isocyanate (NCO:OH) were applied simultaneously to the urea at 70° C. After 5 minutes of rotation, a second identical coat was applied; after 5 additional minutes of rotation, a third identical coat was applied. After the third coat was applied and permitted to cure, the heat source was removed and the sample was air cooled with compressed air. After 10 minutes, the sample had cooled to below 40° C., the drum rotation was stopped and the sample was removed. The coating weight of the polymeric coating was 2.8%, unless indicated otherwise, based on the weight of the urea core. The overall coating had a NCO:OH ratio as provided in the tables below.

Testing Procedure

The samples were tested for their longevity as determined by the rate of dissolution of the coated fertilizer particle in water. To determine the release dissolution rate, 10 grams of sample (either unabraded or abraded) were placed in 100 ml container of water at a selected temperature (i.e., 20° C. for abraded samples and 40° C. for unabraded samples). Water samples were drawn at different time intervals (e.g., 1 day, 2 days, 4, days, 7 days, 9 days, 11 days, 14 days, etc.) and were tested for fertilizer content by measuring the refractive index of the water and comparing the measured refractive index to a calibration curve.

To obtain abraded samples, 30 grams of the sample was dropped through a 20 foot long, 4 inch diameter tube onto a metal plate, after which the above described water release testing was done.

### EXAMPLE 1

In this Example, the effect of the addition of a small molecular diol was demonstrated by adding a small amount of diol to the polyol to provide a coated fertilizer particle with a 2.8% coat weight. The general procedure for coating the fertilizer particles was as described above under METHOD FOR COATING FERTILIZER PARTICLES. The components used in the various samples are listed in Table 1 below. The “Mole Ratio” was the ratio of NCO to OH.

TABLE 1

| | | | | QUADROL | |
|---|---|---|---|---|---|
| | Castor oil | Diol (PDO) | Wax | (Q) | Mole |
| Description | wt-% | wt-% | wt-% | wt-% | Ratio |
| Sample 1 | 91.2 | 0 | 5 | 3.8 | 1.2 |
| (control) | | | | | |
| Sample 2 | 87.2 | 4 | 5 | 3.8 | 1.2 |
| Sample 3 | 0 | 91.2 | 5 | 3.8 | 1.2 |
| (control) | | | | | |

Sample 1 and 3 were control samples; Sample 1 had no small molecular diol present in the coating, and Sample 3 had no polyol in the coating. Sample 2 was an example having a coating formed from the three precursors, isocyanate, polyol, and diol. In this example, the loading amount of diol (i.e., 1,3-propanediol) was 4 wt-% of the polyol mixture. The wax used in the coating of each of the samples was a C₃₀₊HA (alpha olefin wax).

Table 2 shows the water release data at 40 ° C. for unabraded Samples 1-3. Sample 1 exhibited 80.5% release at 18 days. In contrast, Sample 2 exhibited 74.8% nutrient release at same time period. However, Sample 3, coated with the reaction product of the mixture of an isocyanate and 1,3-propanediol, exhibited 86.2% release at 2 days.

TABLE 2

| | Days at 40° C. | | | | | | | | | |
|---|---|---|---|---|---|---|---|---|---|---|
| | 1 | 2 | 4 | 7 | 9 | 11 | 14 | 16 | 18 | 22 |
| Sample 1 | 3.6% | 8.6% | 21.1% | 49.2% | 59.4% | 65.8% | 73.9% | 77.2% | 80.5% | — |
| Sample 2 | 4.3% | 7.9% | 15.9% | 38.4% | 50.0% | 57.8% | 67.5% | 70.7% | 74.8% | 79.7% |
| Sample 3 | 75.4% | 86.2% | — | — | — | — | — | — | — | — |

It is believed that the improved release property of Sample 2 is based on changes to mechanical properties, morphological changes in the polymer film, produced by the reaction product of a mixture including an isocyanate, a small molecule diol and a polyol. The reaction product of this mixture is polyurethane elastomer that has microphase separation between a soft segment derived from polyol and hard segment from a diisocyanate and a diol (1,3-propanediol). This microphase separation presents similar elastomeric properties to those shown for cross-linked rubber networks.

### EXAMPLE 2

In this example, different small molecular diol samples were used to prepare the controlled release fertilizer samples. The specific components used in the various samples are listed in Table 3. In all samples, the primer used was 0.1 wt-% Triethanolamine (TEA) and 0.15 wt-% MDI. “Mole ratio” was the ratio of NCO to OH. The coating applied was 2.8 wt-% of the total coated fertilizer particle. In this example, it is noted that no catalyst was present in the polyol mixture.

TABLE 3

| | Castor oil | Diol EG | PDO | BDO | Wax | Mole |
|---|---|---|---|---|---|---|
| Description | wt-% | wt-% | wt-% | wt. % | wt-% | Ratio |
| Sample 4 (control) | 95 | 0 | 0 | 0 | 5 | 1.2 |
| Sample 5 | 91 | 4 | 0 | 0 | 5 | 1.2 |
| Sample 6 | 91 | 0 | 4 | 0 | 5 | 1.2 |
| Sample 7 | 91 | 0 | 0 | 4 | 5 | 1.2 |

Sample 4 was a control sample, having no small molecular diol. Samples 5, 6 and 7 had a coating formed from the three precursors, isocyanate, polyol, and diol. In this example, the same amount of diol was premixed with castor oil and wax at a level of 5 wt-% of the polyol mixture for each sample. Sample 5 was prepared using ethylene glycol (EG) as the diol, Sample 6 was prepared using 1,3-propanediol (PDO) as the diol, and Sample 7 was prepared using 1,4-butanediol (BDO) as the diol.

Table 4 shows the release data measured at 40 ° C. for unabraded samples of Samples 4-7, and Table 5 shows the data at 20 ° C. of abraded samples (i.e., after drop test) for Samples 4-7. Sample 4, the control sample, exhibited 78.7% release at 20 days at 40 ° C. In contrast, Samples 5, 6, and 7 exhibited 71.4%, 75.4%, and 77.1% nutrient release, respectively, at same time period. Sample 5 with ethylene glycol demonstrated the longest longevity.

Similar results were seen on the abraded samples. Sample 4, the control sample, exhibited 65.7% release at 70 days at 20 ° C. Samples 5, 6 and 7 all had extended lives exceeding the release life of control Sample 4.

TABLE 4

| | Days at 40° C. | | | | | | | | | | | |
|---|---|---|---|---|---|---|---|---|---|---|---|---|
| | 1 | 3 | 6 | 8 | 10 | 13 | 15 | 17 | 20 | 22 | 24 | 27 |
| Sample 4 | 2.8% | 7.1% | 29.2% | 45.2% | 56.1% | 65.7% | 69.7% | 73.0% | 78.7% | — | — | — |
| Sample 5 | 2.1% | 5.7% | 15.9% | 30.0% | 42.9% | 55.4% | 60.9% | 64.9% | 71.4% | 73.8% | 76.2% | 79.5% |
| Sample 6 | 2.8% | 7.1% | 23.2% | 39.8% | 51.4% | 61.7% | 66.5% | 69.7% | 75.4% | 77.9% | — | — |
| Sample 7 | 2.8% | 6.4% | 23.2% | 41.4% | 53.0% | 63.3% | 67.3% | 70.5% | 77.1% | — | — | — |

TABLE 5

| | Days at 20° C. | | | | | | | | |
|---|---|---|---|---|---|---|---|---|---|
| | 1 | 7 | 14 | 21 | 29 | 35 | 49 | 56 | 70 |
| Sample 4 | 7.9% | 21.7% | 30.0% | 36.8% | 42.1% | 45.2% | 52.2% | 56.9% | 65.7% |
| Sample 5 | 6.4% | 18.8% | 27.0% | 32.2% | 37.5% | 40.6% | 47.5% | 50.6% | 56.1% |
| Sample 6 | 7.9% | 19.5% | 28.5% | 33.0% | 38.3% | 41.4% | 49.1% | 53.0% | 60.1% |
| Sample 7 | 6.4% | 18.8% | 28.5 | 35.2% | 40.6% | 43.7% | 52.2% | 56.1% | 62.5% |

### EXAMPLE 3

In this example, different concentrations of diol (i.e., ethylene glycol) were used to prepare controlled release fertilizers. The particular components used in the various samples are listed in Table 6. In all samples, the primer used was 0.1 wt-% Triethanolamine (TEA) and 0.15 wt-% MDI. “Mole ratio” was the ratio of NCO to OH. The coating applied was 2.8 wt-% of the total coated fertilizer particle.

TABLE 6

| | Castor | | | |
|---|---|---|---|---|
| | oil | Diol (EG) | Wax | Mole |
| Description | wt-% | wt-% | wt-% | Ratio |
| Sample 8 (control) | 95 | 0 | 5 | 1.2 |
| Sample 9 | 93 | 2 | 5 | 1.2 |
| Sample 10 | 90 | 5 | 5 | 1.2 |

Sample 8 was a control sample, having no small molecular diol. Samples 9 and 10 had the coating formed from the three precursors, isocyanate, polyol, and diol. Sample 9 was prepared using 2% wt-% ethylene glycol and Sample 10 using 5% wt-% ethylene glycol.

Table 7 shows the release data at 40 ° C. for unabraded Samples 8-10. Sample 8, the control sample, exhibited 77.7% release at 20 days. In contrast, Samples 9 and 10 exhibited 74.6% and 70.5% nutrient release at same time period, respectively. Sample 10 with 5% ethylene glycol has the longest longevity.

TABLE 7

| | Days at 40° C. | | | | | | | | | | |
|---|---|---|---|---|---|---|---|---|---|---|---|
| | 1 | 3 | 6 | 8 | 10 | 14 | 17 | 20 | 22 | 24 | 27 |
| Sample 8 | 2.8% | 7.1% | 30.0% | 44.4% | 56.1% | 68.1% | 73.8% | 77.9% | — | — | — |
| Sample 9 | 2.8% | 6.4% | 22.5% | 37.5% | 49.9% | 63.3% | 69.7% | 74.6% | 77.1% | — | — |
| Sample | 2.8% | 8.6% | 24.0% | 34.5% | 45.2% | 58.5% | 65.7% | 70.5% | 73.8% | 76.2% | 78.7% |
| 10 | | | | | | | | | | | |

### EXAMPLE 4

In this example, a branched chain diol was used to prepare controlled release fertilizers. The particular components used in the various samples are listed in Table 8. Sample 11, without any diol, was a control sample was an applied coating of 3.0 wt-% of the total coated fertilizer particles. Samples 12 and 13, with 3% diol (i.e., 2-methyl-1,3 propane diol), had coatings formed from the three precursors, isocyanate, polyol, and diol. The coatings of Sample 12 and 13 were 3.0 wt-% and 2.8 wt-%, respectively.

The release performance at 40 ° C. of unabraded samples is reported in Table 9. Sample 12 had a significantly lower frontend release (at 7 days) of 31.5% compared to 50.7% of Sample 11. Sample 12 also had increased longevity, from 20 days (Sample 11) to 27 days (Sample 12). Sample 13, even with a reduced coating weight, showed improved frontend release performance (at 7 day)s of 42.1% compared to 50.7% of Sample 11, as well as increased longevity (80% release) at 22 days versus 20 days.

TABLE 8

| | Castor | | Catalyst | | | | |
|---|---|---|---|---|---|---|---|
| | oil | Wax | (TEA) | Diol | | Mole | Coating |
| Description | wt-% | wt-% | wt. % | type | Wt-% | Ratio | Wt % |
| Sample 11 | 92 | 5 | 3 | None | 0 | 1.3 | 3.0 |
| (control) | | | | | | | |
| Sample 12 | 89 | 5 | 3 | MPD | 3 | 1.3 | 3.0 |
| Sample 13 | 89 | 5 | 3 | MPD | 3 | 1.3 | 2.8 |

TABLE 9

| | Days at 40° C. | | | | | | | | |
|---|---|---|---|---|---|---|---|---|---|
| | 1 | 3 | 7 | 10 | 15 | 17 | 20 | 24 | 27 |
| Sample 11 | 2.1% | 10.0% | 50.7% | 63.3% | 73.8% | 73.8% | 77.1% | — | — |
| Sample 12 | 2.8% | 5.0% | 31.5% | 51.5% | 65.7% | 69.0% | 73.8% | 78.8% | 81.2% |
| Sample 13 | 2.8% | 7.9% | 42.1% | 58.5% | 70.5% | 73.7% | 77.8% | 80.3% | — |

In sum, at the same overall coating weight, the fertilizer particles having a coating containing a small molecular diol have longer release life than coated fertilizer particles having no small molecular diol in the coating. However, fertilizer particles coated with a reaction product of a mixture including only an isocyanate and a short diol (as shown by Sample 3 of Example 1) is a poor controlled release fertilizer.

By adding a diol to the coating formed by an isocyanate and polyol, a lower coating weight of the total coating can be used to obtain the same release properties as a coating particle not having a diol in the coating.

Thus, various embodiments of the FERTILIZER GRANULES HAVING A POLYMERIC COATING FORMED WITH A DIOL are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

1-46. (canceled)

47. A controlled release fertilizer composition comprising a plant nutrient core coated with a polyurethane polymeric coating comprising a small molecule diol, wherein the small molecule diol is present at a level of no more than 4 wt-% of the polyurethane polymeric coating.

48. The controlled release fertilizer composition of claim 47, wherein the small molecule diol is present at a level of no more than 3.5 wt-% of the polyurethane polymeric coating.

49. The controlled release fertilizer composition of any of claims 47 wherein the small molecule diol is present at a level of between 1 wt-% and 3 wt-% of the polyurethane polymeric coating.

50. The controlled release fertilizer composition of any of claims 47 wherein the small molecule diol is present at a level of no more than 0.5 wt-% of the fertilizer composition.

51. The controlled release fertilizer composition of any of claims 47 wherein the small molecule diol is present at a level of no more than 0.3 wt-% of the fertilizer composition.

52. The controlled release fertilizer composition of claim 47 wherein the small molecule diol is present at a level of no more than 0.2 wt-% of the fertilizer composition.

53. The controlled release fertilizer composition of any of claims 47 wherein the plant nutrient core comprises at least one nutrient from the nutrients listed below:
Nitrogen derivatives (as nitrogen): 0 wt. %-45.54 wt. %
Phosphorus derivatives (as P₂O₅): 0 wt. %-51.48 wt-%
Potassium derivatives (as K₂O): 0 wt. %-61.38 wt. %
Iron Sulfate: 0 wt. %-99 wt. % Iron EDTA chelate: 0 wt. %-99 wt. %
Copper Sulfate: 0 wt. %-99 wt. %
Manganese Sulfate: 0 wt. %-99 wt. %
Zinc Sulfate: 0 wt. %-99 wt-%
Sodium Molybdate: 0 wt. %-99 wt. %
Sodium Borate: 0 wt. %-99 wt. %, and/or
Magnesium Sulfate: 0 wt. %-99 wt. %.

54. The controlled release fertilizer composition of any of claims 47 wherein the plant nutrient core comprises urea.

55. The controlled release fertilizer composition of any of claims 47 wherein the small molecule diol comprises at least one of ethylene glycol, 1,3-propanediol, 1,4-butanediol, 2-methyl-1,3-propanediol, 1,6-hexanediol, triethylene glycol, tetraethylene glycol, 2-butyl-2-ethyl-1,3-propanediol, 3-methyl-1,5-pentanediol, 2-ethyl-1,3-hexanediol, or combinations thereof.

56. The controlled release fertilizer composition of any of claims 47 wherein the polyurethane polymeric coating is a reaction product of a polyol and an isocyanate.

57. The controlled release fertilizer composition of claim 56 wherein the polyol comprises castor oil.

58. The controlled release fertilizer composition of any of claims 56 wherein the small molecule diol is present with the polyol.

59. The controlled release fertilizer composition of any of claims 56 wherein the small molecule diol is present with the isocyanate.

60. The controlled release fertilizer composition of any of claims 56 wherein the small molecule diol is present with both the polyol and the isocyanate.

61. The controlled fertilizer composition of any of claims 47 wherein the polyurethane polymeric coating comprises at least 3 layers.

62. The controlled release fertilizer composition of any of claims 47 wherein the polyurethane polymeric coating further comprises a wax.

63. The controlled release fertilizer composition of any of claims 47 wherein the polyurethane polymeric coating further comprises a C30+ HA alpha-olefm wax.

64. A process of producing a controlled release fertilizer composition comprising the steps of:
contacting a particulate plant nutrient, optionally coated with a primer layer, with a mixture comprising a small molecule diol and an isocyanate, and a polyol to provide a polyurethane coated particulate plant nutrient; and
curing the polyurethane coated particulate plant nutrient to provide the controlled release fertilizer.

65. The process of claim 64 wherein the small molecule diol is at a level of no more than 6 wt-% of the isocyanate.

66. The process of claim 64 wherein the small molecule diol is at a level of no more than 5.5 wt-% of the polyol.
